(19) United States
(12) Patent Application Publication
(10) Pub. No.: US 2005/0097315 A1
(43) Pub. Date: May 5, 2005

(54) Method and apparatus to configure transmitter and receiver to encrypt and decrypt data

(76) Inventor: Tzahi Carmeli, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/695,837

(22) Filed: Oct. 30, 2003

(51) Int. Cl. H04L 9/00

(52) U.S. Cl. 713/160; 713/181

(57) ABSTRACT

Briefly, a method and apparatus to provide secure communication on wireless networks. The apparatus may include a transmitter and a receiver to encrypt and decrypt a data frame, respectively, and a configuration unit to configure the transmitter and the receiver based on the information included in the data frame.

### BACKGROUND OF THE INVENTION

In wireless local area networks (WLAN) certain data transactions between devices of a basic service set (BSS) may be secured. Security for WLAN, for example, WLAN that complies with IEEE Standard 802.11-1999, may include at least three components: an authentication mechanism or framework; an authentication algorithm; and data frame encryption.

IEEE standard 802.11i, 4.0 draft 2003 provides a method of authentication and encryption/decryption of data frames transferred between two stations. The IEEE standard 802.11i, 4.0 draft 2003 is based on an advance encryption standard (AES) and provides a definition to cipher block chaining (CBC) counter mode (CCM) protocol (CCMP). CCMP provides a message integrity code (SIC) algorithm, which may be used to check the integrity of a received encrypted message. Furthermore, the MIC may be used to provide a MIC frame to a transmitted message.

The IEEE standard 802.11i, 4.0 draft 2003 may define the use of CBC counter mode algorithms, which may be based on a combination of counter mode encryption and CBC-media access control (MAC) authentication. The CBC counter mode algorithm may use an AES engine for encryption.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a block diagram of a station according to some exemplary embodiments of the present invention;

FIG. 3 is an illustration of an exemplary data frame of a wireless communication system using encryption and/or decryption according to exemplary embodiments of the present invention; and

FIG. 4 is a schematic flow chart of a method to authenticate and decrypt and/or encrypt a data frame, according to some exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

It should be understood that the present invention may be used in a variety of applications. Although the present invention is not limited in this respect, the circuits and techniques disclosed herein may be used in many apparatuses such as stations of a wireless communication system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

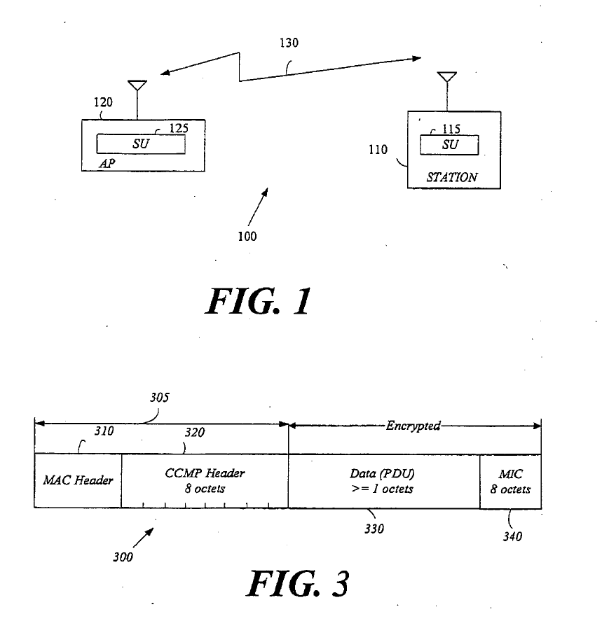

Turning first to FIG. 1, a wireless communication system 100, for example, a WLAN communication system is shown. Although the scope of the present invention is not limited in this respect, the exemplary WLAN communication system 100 may be defined, e.g., by standard IEEE 802.11-1999, as a basic service set (BSS). For example, BSS may include at least one station such as, for example, an access point (AP) 120 and at least one additional station 110, for example, a mobile unit (MU). In some embodiments, station 110 and AP 120 may transmit and/or receive one or more data packets over a communication link 130 of wireless communication system 100. The data packets may include data, control messages, network information, and the like. Additionally or alternatively, in other embodiments of the present invention, WLAN communication system 100 may be a secured network and link 130 may be a secured link to transport data frames over the air. In this exemplary embodiment, AP 120 and station 110 may be equipped with security units (SU) 125 and 115, respectively. Security units 115 and/or 125 may authenticate, encrypt, and/or decrypt data frames transported over secure link 130. For example, security units 115 and/or 125 may encrypt and/or decrypt the data frames according to the standard IEEE-802.11i, although the scope of the present invention is not limited in this respect.

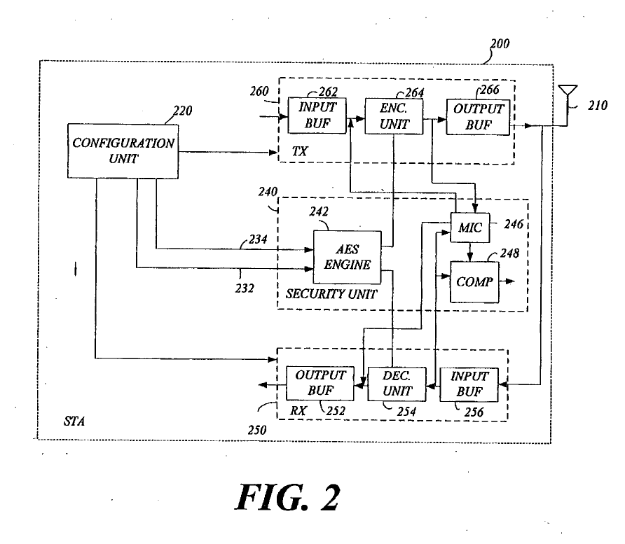

Turning to FIG. 2, a block diagram of a station 200 according to some exemplary embodiments of the present invention is shown. Although the scope of the present invention is not limited in this respect, station 200 may be a mobile unit or an AP of WLAN 100 and may include an antenna 210, a configuration unit 220, a security unit 240, a receiver (RX) 250 and a transmitter (TX) 260.

In embodiments of the present invention, antenna 210 may be used to transport data frames over secured link 130, if desired. Although the scope of the present invention is not limited in this respect, antenna 210 may be an internal antenna, omni-directional antenna, a monopole antenna, a dipole antenna, an end fed antenna, a circularly polarized antenna, a micro-strip antenna, a diversity antenna and the like.

Although the scope of the present invention is not limited in this respect, configuration unit 220 may include a processor and/or registers and/or logic devices and the like. In embodiments of the present invention, configuration unit 220 may configure modes of operation of station 200. For example, configuration unit 220 may configure TX 260 to operate in a transmit mode and RX 250 in a receive mode. In addition, configuration unit 220 may transfer data massages from/to security unit 240. In some embodiments of the present invention, configuration unit 220 may configure security unit 240 to encrypt or decrypt the data frames based on the mode of operation mode of station 200. For example, in a transmit mode, configuration unit 220 may configure security unit 240 to authenticate and encrypt the data frame; in receive mode, configuration unit 220 may configure security unit 340 to decrypt and authenticate the data frame.

Although the scope of the present invention is not limited in this respect, configuration unit 220 may include registers, which may store the configuration information of security unit 240, RX 250 and TX 260. For example, the registers may store properties of the data frame such as, for example, a frame length, a header size, MIC size, AES rounds, encryption counter size, and the like. In addition, the registers of configuration unit 220 may include registers to store initial vectors of RX 250 and/or TX 260 and registers to configure RX 250 and TX 260 to modify the initial vectors, although the scope of the present invention is in no way limited in this respect. It should be understood that embodiments of the present invention may include configuration units that may store the above mentioned types of data and/or other types of data.

Although the scope of the present invention is not limited in this respect, TX 260 may include an input buffer unit 262, an encryption (ENC.) unit 264, and an output buffer unit 266. In some embodiments of the present invention, one or both of input buffer unit 262 and/or output buffer unit 266 may include two independent buffers to enable encryption unit 264 to process data frames and/or portions of data frames in parallel, if desired. For example, encryption unit 264 may perform two operations: authentication of a data frame and encryption of portions of the authenticated portions of the data frame. In some embodiments, encryption unit 264 may authenticate the data frame by performing an exclusive OR (XOR) operation between the data frame, which may be provided by input buffer 262, and an authentication vector, which may be provided by an AES engine 242. The encryption operation may performed by performing a XOR operation between the data frame and an encryption vector, which may be provide by AES engine 242. Output buffer 266 may output the encrypted authenticated data to a radio frequency (RF) transmitter (not shown) to be transmitted via antenna 210, if desired.

Although the scope of the present invention is not limited in this respect, in some embodiments the authentication vector may include one byte of flags, one byte of quality of service bits, six bytes of a second address in the MAC header, six bytes of initial vector (IV) and two bytes that indicate the length of the vector. The encryption vector may include one byte of flags, one byte of quality of service bits, six bytes of a second address in the MAC header, six bytes of IV and two bytes that may be set to “1” by AES engine 242, if desired.

Although the scope of the present invention is not limited in this respect, RX 250 may include an input buffer 252, a decryption (DEC.) unit 254, and an output buffer 256. In some embodiments of the present invention, input buffer 252 and/or output buffer 256 may include two independent buffers to enable decryption unit 254 to process the portions of the data frame and/or data frames in parallel, if desired. For example, decryption unit 254 may perform two operations: authentication of the data frame and decryption of portions of the data frame. In some embodiments, decryption unit 254 may decrypt portions of an encrypted data frame by performing a XOR operation between the portions of the encrypted data frame, provided by input buffer 252, and the encryption vector, which may be provided by AES engine 242. Authentication of the decrypted data frame may be achieved by performing a XOR operation between the decrypted data frame, which may be outputted from input buffer 252, and the authentication vector, which may be provided by AES engine 242. Output buffer 256 may output the authenticated decrypted data to a baseband unit (not shown) of station 200, if desired.

Although the scope of the present invention is not limited in this respect, the data frame may be divided into blocks having a predetermined block size. In embodiments of the present invention, authentication and decryption or encryption may be preformed by decryption unit 254 and/or encryption unit 264 by performing a XOR operation between a block of the data frame and one of the vectors of AES engine 242. In some embodiments of the present invention, the last block of the data frame may be padded with a sequence of zero values as necessary to align the block size with the predetermined, if desired.

Although the scope of the present invention is not limited in this respect, security unit 240 may include the AES engine 242, a MIC generator 246 and comparator 248. In some embodiment of the present invention, data frames may be inputted to AES engine 240 from encryption unit 264 or decryption unit 254. Based on the mode of operation of station 200, configuration unit 220 may configure AES engine 240 operation. For example, when station 200 is in the receive mode of operation, configuration unit 220 may configure AES engine 242, via a command line 234, to provide the encryption vector and the authentication vector to decryption unit 254. AES engine 242 may generate the encryption vector and the authentication vector by performing an AES algorithm on data received from decryption unit 254, if desired. In the transmit mode of operation of station 200, AES engine 242 may be configured by a command line 232 to provide the encryption vector and the authentication vector to encryption unit 264. AES engine 242 may generate the encryption vector and the authentication vector by performing an AES algorithm on data received from encryption unit 264, if desired. Although the scope the present invention is not limited in this respect, AES engine 242 may by implemented by software or by hardware or by any desired combination of software and hardware.

Although the scope of the present invention is not limited in this respect, in the transmit mode, MIC generator 246 may be used to generate the MIC portion of a transmitted data frame. The generation of the MIC portion may be performed according to the CCM algorithm, if desired. In the receive mode, MIC generator 246 may provide a calculated MIC of a received data frame. The calculated MIC may be compared with a decrypted MIC of the received data frame to test the validity of the received data frame. The comparison may be done by comparator 248. Although the scope the present invention is not limited in this respect, MIC generator 246 may be implemented by software or by hardware or by any desired combination of software and hardware.

Turning to FIG. 3, an illustration of an exemplary data frame 300 in a wireless communication system incorporating encryption and/or decryption according to exemplary embodiments of the present invention is shown. Although the scope of the present invention is not limited in this respect, the exemplary data frame 300 may be defined by IEEE-802.11i standard and may include a header 305 which may include a MAC header 310 and a CCM protocol (CCMP) header, a data portion 330, and a MIC portion 340.

Although the scope of the present invention is not limited in this respect, header 305 may be authenticated but not decrypted or encrypted by decryption unit 254 and/or encryption unit 264. However, Data 330 and MIC 340 may be authenticated and decrypted or encrypted by decryption unit 254 and/or encryption unit 264.

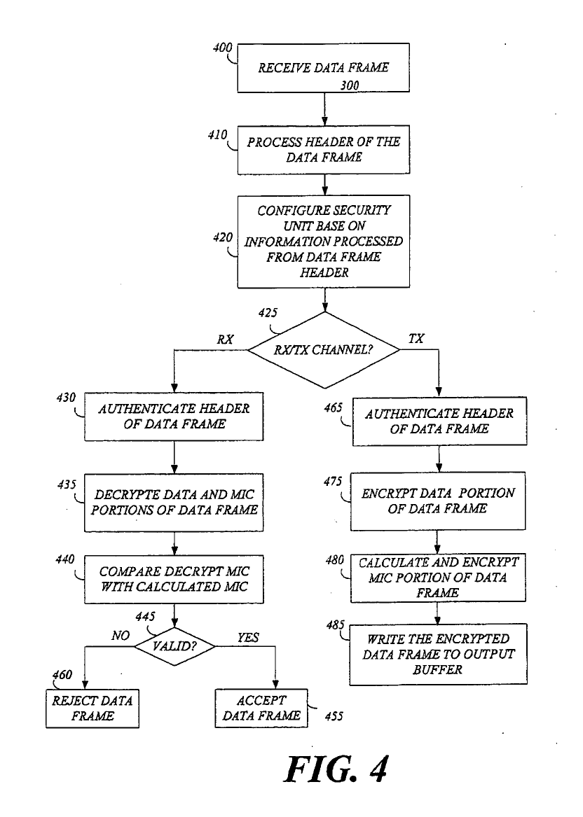

Turning to FIG. 4, a schematic illustration of a flow chart of a method to authenticate and decrypt and/or encrypt a data frame, according to some exemplary embodiments of the present invention is shown. Although the scope of the present invention is not limited in this respect, a data frame (e.g. data frame 300) may be received, for example, by RX 250 and/or TX 260 and may be stored in input buffer 256 and/or input buffer 262, respectively (text box 400). Header 305 of data frame 300 may be processed for example, by decryption unit 254 and/or by encryption unit 264 based on the operation mode of station 200 (text box 410). In some embodiments of the invention, the process header my include information such as, for example, frame length, encryption key, initial vector (IV), etc., and configuration unit 220 may configure security unit 240 based on the header information.

Although the scope of the present invention is not limited in this respect, configuration unit 220 may configure security unit 240 operation based on the information processed from header 305 (text box 420). For example, if the information of the header indicates that the data frame is an encrypted data frame, then configuration unit 220 may configure AES engine 242 to generate and provide the encryption vector to decryption unit 254. Furthermore, if the information of the header indicated that the data frame is authenticated data frame, then configuration unit 220 may configure AES engine 242 to generate and provide the authentication vector to encryption unit 264. In addition, if the information of the header indicated that the data frame is not authenticated or encrypted data frame, then configuration unit 220 may configure AES engine 242 to generate and provide the authentication vector to encryption unit 264 or to decryption unit 254, depending on the mode of operation of station 200.

Although the scope of the present invention is not limited in this respect, according to the configuration of security unit 240 and the mode of operation of station 200, the data frame may be processed by TX channel (e.g., TX 260, and security unit 240) or by RX channel (e.g., RX 260, and security unit 240), as indicated at in text box 425.

Referring first to the RX channel in FIG. 2, decryption unit 254 may authenticate the header of the data frame (text box 430), decrypt the data (e.g., data 330) and the MIC portions (e.g., MIC 340) of data frame 300 (text box 435). In some embodiments of the invention, the MIC may be calculated by MIC generator 246 and may be compared, for example, by comparator 248, to the decrypted MIC (text box 440). The comparison result may provide an indication on the validity of data frame 300 (text box 445). In some embodiments of the present invention, the security unit 240 may accept valid data frames (text box 455) or reject invalid data frames (text box 460). It should be understood that, in other embodiments of the present invention, other components and/or units and/or modules may accept or reject the data frame based on its validity, if desired.

Referring to the TX channel in FIG. 2, although the scope of the present invention is not limited in this respect, encryption unit 264 may authenticate the header of the data frame (e.g., data frame 300), as indicated at box 465. Encryption unit 264 may authenticate and encrypt the data portion of the data frame (text box 475). In some embodiments of the invention, MIC generator 246 may generate the MIC portion of the data frame (e.g., MIC 340) and encryption unit 264 may encrypt the MIC (text box 480). The encrypted data frame may be written into output buffer 256 (text box 485).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
configuring a transmitter and a receiver to encrypt and decrypt, respectively, a data frame based on information included in a header of the data frame.

2. The method of claim 1, further comprising authenticating the header of the data frame.

3. The method of claim 1, further comprising:
processing the header of the data frame to provide a processed header; and
configuring the transmitter and the receiver based on information included in the processed header.

4. The method of claim 1 wherein configuring comprises:
configuring the receiver to authenticate and decrypt a data portion and a message integrity code portion of the data frame.

5. The method of claim 4 comprising:
decrypting the data portion and the message integrity code portion of the data frame to provide a decrypted data portion and a decrypted message integrity code portion, respectively;
calculating the message integrity code of the data frame from the decrypted data portion; and
comparing the calculated message integrity code to the decrypted message integrity code portion.

6. The method of claim 1, wherein configuring comprises:
configuring the transmitter to authenticate and to encrypt the data portion and a message integrity code based on information included in the header of said data frame.

7. The method of claim 6, further comprising:
dividing the data portion into two or more blocks of a predetermined block size; and
padding a last block of the data portion with one or more zeros to match the predetermined block size.

8. the method of claim 1 further comprising:
generating an encryption vector to be used to encrypt and decrypt the data frame.

9. The method of claim 1, further comprising:
generating an authentication vector to be used to authenticate the data frame.

10. The method of claim 8, further comprising:
decrypting one or more encrypted portions of the data frame by performing an exclusive OR operation between the one or more encrypted portions of the data frame and the encryption vector.

11. The method of claim 8, further comprising:
encrypting one or more portions of the data frame by applying an exclusive OR operation between the one or more portions of the data frame and the encryption vector.

12. An apparatus comprising:
a transmitter to encrypt a data frame;
a receiver to decrypt the data frame; and
a configuration unit to configure the transmitter and the receiver based on information included in the data frame.

13. The apparatus of claim 12, comprising:
a security unit to provide an encryption vector to the transmitter and to the receiver based on the configuration of the transmitter and the receiver.

14. The apparatus of claim 12, comprising:
a security unit to provide an authentication vector to the transmitter and to the receiver based on the configuration of the transmitter and the receiver.

15. The apparatus of claim 13, wherein the receiver includes a decryption unit to provide a decrypted data frame by applying the encryption vector to an encrypted data frame.

16. The apparatus of claim 13, wherein the transmitter includes an encryption unit to receive an authenticated data frame and the encryption vector to provide an encrypted data frame.

17. The apparatus of claim 13, wherein the security unit comprises:
an advance encryption standard engine to generate the encryption vector and an authentication vector.

18. The apparatus of claim 13, wherein the security unit comprises:
a message integrity code generator to generate a message integrity code of the encrypted data frame and to calculate a message integrity code of a decrypted data message.

19. The apparatus of claim 18, wherein the security unit comprises.
a comparator to compare between the calculated message integrity code and a decrypted message integrity code.

20. An apparatus comprising:
a transmitter to encrypt a data frame;
a receiver to decrypt the data frame; and
a configuration unit to configure the transmitter and the receiver based on information included in the data frame.

21. The apparatus of claim 20, comprising:
a security unit to provide an encryption vector to the transmitter and to the receiver based on the configuration of the transmitter and the receiver.

22. The apparatus of claim 20, comprising:
a security unit to provide an authentication vector to the transmitter and to the receiver based on the configuration of the transmitter and the receiver.

23. The apparatus of claim 21, wherein the receiver includes a decryption unit to provide a decrypted data frame by applying the encryption vector to an encrypted data frame.

24. The apparatus of claim 21, wherein the transmitter includes an encryption unit to receive an authenticated data frame and the encryption vector to provide an encrypted data frame.

25. The apparatus of claim 21, wherein the security unit comprises:
an advance encryption standard engine to generate the encryption vector and an authentication vector.

26. A wireless communication system comprising:
two or more stations wherein at least one station of the two or more stations includes:
a transmitter to encrypt a data frame;
a receiver to decrypt the data frame; and
a configuration unit to configure the transmitter and the receiver based on information included in the data frame.

27. The apparatus of claim 26, comprising:
a security unit to provide an encryption vector to the transmitter and to the receiver based on the configuration of the transmitter and the receiver.

28. The apparatus of claim 26, comprising:
a security unit to provide an authentication vector to the transmitter and to the receiver based on the configuration of the transmitter and the receiver.

29. The apparatus of claim 27, wherein the receiver comprises a decryption unit to provide a decrypted data frame by applying the encryption vector to an encrypted data frame.

30. The apparatus of claim 27, wherein the transmitter comprises an encryption unit to receive an authenticated data frame and the encryption vector to provide an encrypted data frame.

31. The apparatus of claim 27, wherein the security unit comprises:
an advance encryption standard engine to generate the encryption vector and an authentication vector.

32. An article comprising: a storage medium, having stored thereon instructions, that when executed, result in:
configuring a transmitter and a receiver to encrypt and decrypt, respectively, a data frame based on information included in a header of the data frame.

33. The article of claim 32, wherein the instructions when executed, result in:
configuring the receiver to authenticate and decrypt data portion and a message integrity code portion of the data frame.

34. The article of claim 32, wherein the instruction when executed, result in:
generating an encryption vector to be used to encrypt and decrypt the data frame based on information included in a header of the data frame.

35. The article of claim 32, wherein the instruction when executed, result in:
generating an authentication vector to be used to authenticate the data frame.

36. The article of claim 32, wherein the instruction when executed, result in:
decrypting one or more encrypted portions of the data frame by performing an exclusive OR operation between the one or more encrypted portions of the data frame and the encryption vector.
